(19) United States
(12) Patent Application Publication
(10) Pub. No.: US 2004/0206583 A1
(43) Pub. Date: Oct. 21, 2004

(54) Method and arrangement for telemonitoring an elevator

(76) Inventors: John Mearns, Hoofddorp (NL); Tapio Tyni, Hyvinkaa (FI); Pekka Perala, Helsinki (FI); Nils-Robert Roschier, Vantaa (FI)

Correspondence Address: BIRCH STEWART KOLASCH & BIRCH, PO BOX 747, FALLS CHURCH, VA, 22040-0747, US

(21) Appl. No.: 10/832,291

(22) Filed: Apr. 27, 2004

Related U.S. Application Data
(63) Continuation of application No. PCT/FI03/00085, filed on Mar. 2, 2003.

(30) Foreign Application Priority Data
Feb. 5, 2002 (FI) 20020234

(51) Int. Cl. B66B 1/34

(52) U.S. Cl. 187/391

(57) ABSTRACT

Method for telemonitoring the condition and state of an elevator and for determining its need for maintenance by performing an automatic test run of the elevator car (1) in the elevator shaft (2) to collect data for use in an elevator telemonitoring process. The method of the present invention is characterized in that the aforesaid test run comprises a number of automatic test run cycles synchronized with respect to each other.

The present invention relates to a method as defined in the preamble of claim 1 for telemonitoring the condition and state of an elevator and for determining its need for maintenance. The invention also relates to an arrangement as defined in the preamble of claim 16 for telemonitoring the condition and state of an elevator and for determining its need for maintenance.

Condition monitoring refers to the procedures whereby the condition of equipment is generally observed by measuring parameters the changes of which reflect a change in the condition of the equipment. In condition monitoring in general, the condition of equipment is monitored regularly and when the condition changes, a more accurate fault diagnosis can be made. Fault diagnostics again refers to the procedures used to detect and identify a fault and to determine the cause of the fault. The most important function of a fault diagnostics system is to detect the fault reliably and safely as early as possible. Sometimes a fault diagnostics system is programmed to suggest a solution for eliminating the fault detected. The aforesaid principle is also utilized in telemonitoring of the condition and state of elevators and likewise in the determining of the need for preventive maintenance of elevators.

In telemonitoring of the condition and state of elevators, the elevators themselves provide and indication of faults to be expected. Thus, the degree of wear of components can be detected before they break down completely. It is therefore possible to preset a fixed target value for the failure frequency of elevators to measure the reliability and quality of the elevator. For example, the target per annum for each elevator could be set at only one fault interrupting the passenger's elevator journey.

The aim of preventive maintenance of an elevator is to eliminate the deterioration of the condition and performance of the equipment occurring in consequence of environmental effects, use and wear. Environmental factors and harder-than-anticipated use accelerate wear of the elevator and may lead to faults. For example, transporting big and heavy objects on an elevator designed for passenger traffic may result in a loosening of joints, changes of adjustments and impairment of the quality of operation of the elevator. Environmental factors such as dust, dirt, temperature and moisture additionally affect the condition and rate of wear of the elevator. If the elevators are not serviced in time, they may develop faults that either prevent passengers from using the elevator at all or impair the quality of operation of the elevator in a decisive way, e.g. the door operation becomes noisy or too slow. The scheduling of preventive maintenance of elevators has conventionally been done either via periodic visits set on certain dates in the calender or based on the extent of usage.

Prior-art technology is described in published application GB 2226428 (B66B 5/02), from which a telemonitoring and diagnostics system comprising several elevators and their monitoring terminals and a telemonitoring center communicating with them is known. Each elevator monitoring terminal observes the history and state of operation and deviations from the normal state of the elevator and sends the information periodically to the maintenance center, which generates the maintenance commands. This system is used to monitor door faults, door drives, condition of the motor, the stopping position and brakes of the elevator, operation of the control system, rope elongation, etc. The maintenance center, communicating with the aforesaid elevator monitoring terminals over telephone lines, is provided with a diagnostics program and a monitor for receiving and analyzing the operation data and history. By these means, based on information obtained from the operation history of the elevators, the system tries to prevent faults caused by aging.

The known state of the art is also represented by published application JP228046/1999, which discloses a telemonitoring system for elevators. In this system, information is collected from inside the elevator by means of cameras and microphones, and the information describing the condition of the car is sent to a telemonitoring unit, whereafter a decision making unit makes decisions regarding abnormal conditions. Problem situations detected are reported to the telemonitoring center. In this system, the elevator in which problems have been detected is also sent instructions for coping with the problems. In the system presented in this publication, the cameras and microphones are active even when passengers are present in the elevator.

The problem with prior-art solutions is that the information collected about the elevator is not necessarily always sufficiently accurate, in consequence of which the elevator telemonitoring system may give a false alarm based on an incorrect interpretation.

The object of the present invention is to overcome the drawbacks of the aforesaid prior art.

In precise terms, the method of the invention for telemonitoring the condition and state of an elevator and determining its need for maintenance is characterized by what is presented in the characterization part of claim 1. The arrangement of the invention for telemonitoring the condition and state of an elevator and determining its need for maintenance is characterized by what is presented in the characterization part of claim 16. The features of preferred embodiments of the invention are disclosed in the subclaims.

The method of the invention provides significant advantages as compared with prior-art technology.

The advantage achieved by the invention is that the information collected about the elevator is sufficiently accurate because the test run comprises several test run cycles of equal length in time and distance and synchronized with each other in respect of the duration of and distance traveled during the test run. Therefore, it is possible to compare the information collected during different test run cycles because on each test run cycle the elevator car is always at the same floor after the same length of time. Thus, it is also possible to more effectively prevent the possibility of a false elevator fault alarm.

The present invention concerns a method for telemonitoring the condition and state of an elevator and determining its need for maintenance by performing an automatic test run of the elevator car in the elevator shaft to collect information for use by an elevator telemonitoring process. According to the method of the invention, the aforesaid test run comprises several automatic test run cycles synchronized with each other so that information is collected as a function of time and traveling distance of the elevator car. According to a preferred embodiment of the invention, the number of test run cycles mentioned above is three. In the method, information is collected by means of devices provided in connection with the elevator car for collecting audio data and video data and door data and car movement data and car stopping data for use as measurement data. These aforesaid measuring devices collecting measurement data include e.g. video cameras, microphones, acceleration sensors, car load weighing devices, photocells, etc.

Several test run cycles as mentioned above are performed, their number being not limited in any way. The number of test run cycles performed is preferably three.

According to a preferred embodiment of the invention, the method comprises testing whether the test run cycles for testing the elevator car can be started by testing in some way before starting the test run cycles whether the aforesaid elevator car is empty, e.g. by checking by some method or means whether there are people or goods present in the elevator car.

According to the method of the invention, as the starting place for the aforesaid elevator car is sought a given floor, whereupon car calls to the other floors are issued to begin a first test run cycle of the elevator car from the starting place, and the audio and video data of a first video camera placed inside the elevator car and the door data and car movement data and car stopping data are saved as measurement data.

According to the method of the invention, as the starting place for the aforesaid elevator car is sought a given floor, whereupon car calls to the other floors are issued and then a second test run cycle of the elevator car is started from the starting place, the audio and video data of a second video camera placed below the elevator car and the door data and car movement data and car stopping data are stored as measurement data.

According to the method of the invention, as the starting place for the aforesaid elevator car is sought a given floor, whereupon car calls to the other floors are issued and then a third test run cycle of the elevator car is started from the starting place, the audio and video data of a third video camera placed on top of the elevator car or in the machine room of the elevator and the door data and car movement data and car stopping data are stored as measurement data.

According to the method of the invention, a mean value is calculated from the measurement data comprising the door data and car movement data and car stopping data for the first, second and third test run cycles of the aforesaid elevator car. After this, according to the invention, the mean value thus calculated is compared to a reference value corresponding to a normal condition or state of the elevator.

The invention also relates to an arrangement for telemonitoring the condition and state of an elevator and determining its need for maintenance by performing an automatic test run of the elevator car in the elevator shaft to collect information for use by an elevator telemonitoring process. According to the present invention, the arrangement comprises video cameras provided in connection with the elevator car for collecting video data and audio data, and door data and car movement data and car stopping data, which are collected and are stored during a test run comprising a number of automatic test run cycles synchronized with each other.

According to a preferred embodiment of the invention, arranged in connection with the elevator car is a first video camera placed inside the elevator car for collecting video and/or audio data and a second video camera placed below the aforesaid elevator car. According to the invention, arranged in connection with the elevator car is a third video camera collecting video and/or audio data and placed on top of the aforesaid elevator car or alternatively in the machine room of the elevator in immediate vicinity of the drive machine of the elevator.

In the following, the invention will be described in detail with reference to the attached drawings, wherein

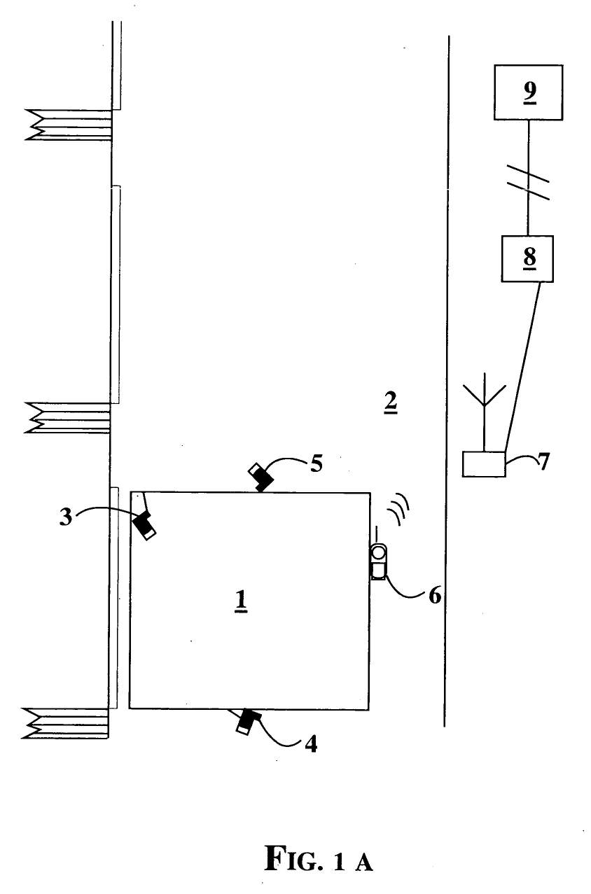

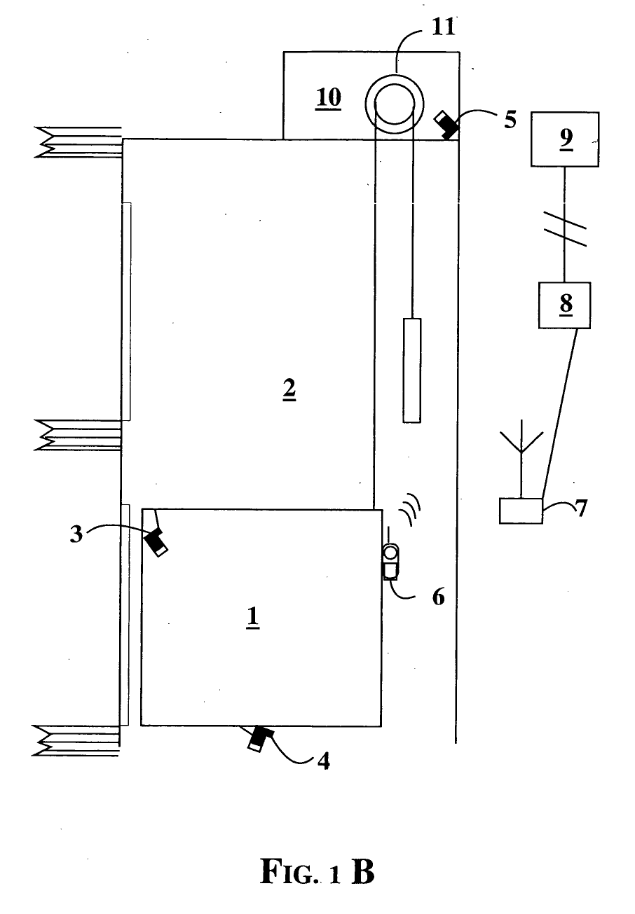

FIG. 1A represents an arrangement according to the best embodiment of the invention for telemonitoring the condition and state of an elevator,

FIG. 1B represents another arrangement according to the invention for telemonitoring the condition and state of an elevator,

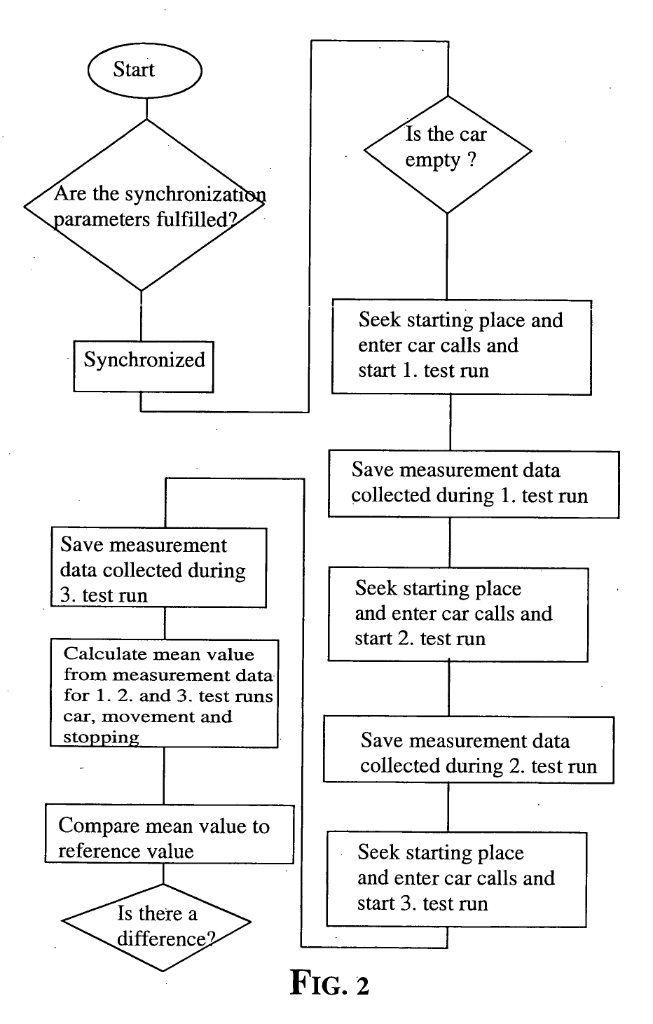

FIG. 2 presents a block diagram visualizing the method of the invention.

FIG. 1A represents an arrangement according to the best embodiment of the invention for telemonitoring the condition and state of an elevator, wherein the condition and state of the elevator are telemonitored and its need for maintenance is determined by performing an automatic test run of the elevator car 1 in the elevator shaft to collect information for use in an elevator telemonitoring process.

The above-mentioned arrangement comprises video cameras 3, 4, 5 provided in connection with the elevator car 1, which are used to collect information for use in the telemonitoring of the condition and state of the elevator. Also provided in connection with the elevator are means for collecting door data and means for collecting car movement data and means for collecting car stopping data, which are likewise used to collect information for use in the telemonitoring of the condition and state of the elevator. The elevator car 1 comprises a wireless transmitter 6 for transmitting the collected measurement data to a receiver 7, which communicates with an elevator-specific monitoring terminal 8 provided with a special card. This aforesaid monitoring terminal 8 again sends the measurement data over a communication link to a maintenance center 9 for analysis. The aforesaid communication link for transmitting the measurement data may preferably consist of a telephone connection or an Internet connection or some other wireless connection.

According to this embodiment, the aforesaid video cameras collecting information about the elevator are so disposed that the first video camera 3 is placed inside the elevator car 1 and the second video camera 3 is placed below the elevator car 1 while the third video camera 5 is placed on top of the elevator car 1.

FIG. 1B represents another arrangement for monitoring the condition of an elevator, which is like the arrangement for telemonitoring the condition and state of an elevator except that the third video camera 5 collecting information is disposed in the immediate vicinity of the elevator drive machine 11 in the machine room 10 of the elevator. This arrangement is advantageous in the detection of faults occurring in the drive machine 11 of the elevator.

FIG. 2 visualizes a method according to the present invention associated with the telemonitoring of elevators, in the form of a block diagram visualizing the method of the invention as a step-by-step procedure.

The invention discloses a method for telemonitoring the condition and state of an elevator and determining its need for maintenance by performing an automatic test run of an elevator car 1 in an elevator shaft 2 to collect information for use in an elevator telemonitoring process. The method of the invention is characterized in that the aforesaid test run comprises several automatic test run cycles synchronized with each other. According to a preferred embodiment of the invention, the number of above-mentioned test run cycles is three.

In the method, first a check is carried out to establish whether all the synchronization parameters are fulfilled. If all the aforesaid synchronization parameters are fulfilled, then it is concluded that synchronization prevails, whereupon the aforesaid test run cycles are started. This an essential feature of the invention, because the automatic test run cycles according to the invention can thus be carried out in synchronization with each other, rendering the aforesaid test run cycles mutually comparable so that comparable data is produced during them. One of the most important synchronization parameters is the traveling times between the floor designated as the starting floor and each one of the other floors, which traveling times must be the same on each test run cycle. Another synchronization parameter is the stopping time at each floor during each test run cycle, which stopping times preferably must be the same for each floor during every test run cycle.

During the test run cycles of the elevator to be telemonitored, audio and video data and door data and car movement data and car stopping data is collected as measurement data by using means specially applicable for this purpose.

In the method of the invention, a test is performed to establish whether it is possible to carry out the test run cycles of the aforesaid elevator car 1. This can be implemented by testing in some way before starting the test run cycles whether the aforesaid elevator car 1 is empty. This may be based e.g. on utilizing the car load weighing device so that, the weight of an empty car being known, it will be established before starting the test run cycles whether there are any people present in the aforesaid elevator car 11 or not.

During the next step in the procedure according to the method of the invention, as the starting place for the aforesaid elevator car 1 is sought a given floor, whereupon car calls to the other floors are issued, whereupon the first test run cycle of the aforesaid elevator car 1 is started from the aforesaid floor designated as the starting place, and the audio and video data of the first video camera 3 placed inside the aforesaid elevator car 1 and the door data and car movement data and car stopping data are stored as the measurement data obtained for the first test run cycle.

During the next step in the procedure according to the method of the invention, as the starting place for the aforesaid elevator car 1 is sought a given floor, whereupon car calls to the other floors are issued, whereupon the second test run cycle of aforesaid elevator car 1 is started from the aforesaid floor designated as the starting place, and the audio and video data of the second video camera 4 placed below the aforesaid elevator car 1 and the door data and car movement data and car stopping data are stored as the measurement data obtained for the second test run cycle.

After this, according to the method of the invention, as the starting place for the aforesaid elevator car 1 is sought a given floor, whereupon car calls to the other floors are issued, whereupon the third test run cycle of the aforesaid elevator car 1 is started from the aforesaid floor designated as the starting place, and the audio and video data of the third video camera 5 placed on top of the aforesaid elevator car 1 or in the elevator machine room and the door data and car movement data and car stopping data are stored as the measurement data.

At this stage, the measurement data for each test run cycle have been stored for used in the elevator condition monitoring system.

After this, based on the method, a mean value is calculated from the measurement data comprising the door data and car movement data and car stopping data for the first, second and third test run cycles of the aforesaid elevator car 1.

Next, the mean value thus calculated is compared to a reference value corresponding to a normal condition or state of the elevator. Based on this comparison, the elevator condition monitoring system knows whether a failure is likely to occur in the elevator system in the near future or not. Thus, it is possible to start preventive maintenance operations in time before a failure occurs and to prevent the interruption of the elevator journey of passengers who may be present in the elevator car.

According to the invention, the aforesaid first, second and third test run cycles of the aforesaid elevator car 1 are preferably started from the same floor designated as the starting floor.

According to an embodiment of the method of the invention, the floor designated as the starting place of the test run cycle for the aforesaid elevator car 1 may be the top floor.

According to another embodiment of the invention, the aforesaid first, second and third test run cycles of the aforesaid elevator car 1 are synchronized so that each floor-to-floor trip is started with a separate synchronization. In this case, each car call is issued from the destination floor of the previous car call. For example, the elevator car is driven from the first floor to the second floor and a car call to the next i.e. third floor is not given until the door has been closed and the elevator is ready to continue. By dividing the test run cycles into short stretches in this manner, the error accumulated during the test run cycle is minimized, which is advantageous especially in the case of high buildings.

In addition, according to the method, the test run cycles of the aforesaid elevator car 1 are repeated as many times as necessary, measuring the same or different information.

In the foregoing, the invention has been described by way of example with reference to the attached drawings while different embodiments of the invention are possible in the scope of the inventive concept defined in the claims.

1. Method for telemonitoring the condition and state of an elevator and for determining its need for maintenance by performing an automatic test run of the elevator car (1) in the elevator shaft (2) to collect data for use in an elevator telemonitoring process, characterized in that the aforesaid test run comprises a number of automatic test run cycles synchronized with respect to each other so that information is collected as a function of time and the distance traveled by the elevator car (1).

2. Method according to claim 1, characterized in that the test run preferably comprises three test run cycles mentioned above.

3. Method according to claim 1 or 2, characterized in that, during the aforesaid test run cycles, audio data and video data and door data and car movement data and car stopping data is collected.

4. Method according to claim 3, characterized in that a test is executed to determine whether it is possible to start the test run cycles of the aforesaid elevator car (1).

5. Method according to claim 3, characterized in that, before the test run cycles are started, a test is executed to determine whether the aforesaid elevator car (1) is empty.

6. Method according to claim 3, characterized in that, before the test run cycles are started, the aforesaid elevator car (1) is checked for the presence of people in the car.

7. Method according to claim 1, characterized in that as the starting place for the aforesaid elevator car (1) is sought a given floor, whereupon car calls to the other floors are issued, whereupon the first test run cycle of the elevator car (1) is started from the aforesaid starting place, the audio and video data of a first video camera (3) placed inside the aforesaid elevator car (1) and the door data and car movement data and car stopping data are saved as measurement data.

8. Method according to claim 1, characterized in that as the starting place for the aforesaid elevator car (1) is sought a given floor, whereupon car calls to the other floors are issued, whereupon the second test run cycle of the elevator car (1) is started from the aforesaid starting place, the audio and video data of a second video camera (4) placed below the aforesaid elevator (1) car and the door data and car movement data and car stopping data are stored as measurement data.

9. Method according to claim 1, characterized in that as the starting place for the aforesaid elevator car (1) is sought a given floor, whereupon car calls to the other floors are issued, whereupon the third test run cycle of the elevator car (1) is started from the aforesaid starting place, the audio and video data of a third video camera (5) placed on top of the elevator car or in the machine room of the elevator and the door data and car movement data and car stopping data are stored as measurement data.

10. Method according to claim 9, characterized in that a mean value is calculated from the measurement data comprising the door data and car movement data and car stopping data for the first, second and third test run cycles of the aforesaid elevator car (1).

11. Method according to claim 10, characterized in that the mean value thus calculated is compared to a reference value corresponding to a normal condition or state of the elevator.

12. Method according to claim 1, characterized in that the aforesaid first, second and third test run cycles of the aforesaid elevator car (1) are started from the same floor designated as the starting place.

13. Method according to claim 1, characterized in that the aforesaid first, second and third test run cycles of the aforesaid elevator car (1) are started from the top floor.

14. Method according to claim 1, characterized in that the aforesaid first, second and third test run cycles of the aforesaid elevator car (1) are synchronized so that each floor-to-floor trip is started with a separate synchronization.

15. Method according to claim 1, characterized in that the test run cycles of the aforesaid elevator car (1) are repeated as many times as necessary, measuring the same or different information.

16. Arrangement for telemonitoring the condition and state of an elevator and for determining its need for maintenance by performing an automatic test run of the elevator car (1) in the elevator shaft (2) to collect data for use in an elevator telemonitoring process, characterized in that the arrangement comprises video cameras (3, 4, 5) provided in connection with the elevator car (1) and means for collecting door data and means for collecting car movement data and means for collecting car stopping data, said means being used to collect information during the test run, which comprises several test run cycles.

17. Arrangement according to claim 16, characterized in that it comprises in connection with the elevator car (1) a first video camera (3) for collecting video and/or audio data, disposed inside the aforesaid elevator car (1), and a second video camera (4) disposed below the aforesaid elevator car (1).

18. Arrangement according to claim 16, characterized in that it comprises in connection with the elevator car (1) a third video camera (5) for collecting video and/or audio data, disposed on top of the aforesaid elevator car (1).

19. Arrangement according to claim 16, characterized in that it comprises in connection with the elevator car (1) a third video camera (5) for collecting video and/or audio data, disposed in the elevator machine room (10) in the immediate vicinity of the drive machine (11) of the elevator.

20. Arrangement according to claims 16-19, characterized in that the elevator car (1) comprises a wireless transmitter (6) for transmitting the measurement data to a receiver (7) communicating with an elevator-specific monitoring terminal (8) comprising a special card.

21. Arrangement according to claim 20, characterized in that the aforesaid monitoring terminal (8) sends the measurement data over a communication link to a maintenance center (9).
